(19) United States
(12) Patent Application Publication
(10) Pub. No.: US 2026/0303266 A1
(43) Pub. Date: Oct. 1, 2026

(54) RESOURCE EFFICIENCY FOR RETRANSMISSION

(71) Applicant: QUALCOMM Incorporated, San Diego, CA (US)

(72) Inventors: Shijun WU, San Diego, CA (US); Kapil GULATI, Belle Mead, NJ (US); Shailesh PATIL, San Diego, CA (US)

(21) Appl. No.: 19/094,628

(22) Filed: Mar. 28, 2025

(51) Int. Cl. H04L 1/1812; H04W 72/25

(52) U.S. Cl. CPC H04L 1/1812; H04W 72/25

(57) ABSTRACT

Apparatus, methods, and computer program products for wireless communication are provided. An example method may include transmitting, to a second wireless device, a first transmission including a first transport block (TB) associated with a set of portions, where control information associated with the first transmission includes a resource reservation for the first transmission and at least one subsequent resource reservation. The example method may further include receiving, from the second wireless device, a hybrid automatic repeat request (HARQ) feedback indicating a decoding failure associated with at least one portion of the set of portion. The example method may further include transmitting, to the second wireless device, a second transmission based on the at least one subsequent resource reservation, where the second transmission includes the at least one portion of the set of portion associated with the first TB and at least a portion of a second TB.

### TECHNICAL FIELD

The present disclosure relates generally to communication systems, and more particularly, to wireless communication systems with retransmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first wireless device (e.g., a user equipment (UE) or a network entity) are provided. The apparatus may include at least one memory and at least one processor coupled to the at least one memory. Based at least in part on information stored in the at least one memory, the at least one processor, individually or in any combination, is configured to (e.g., cause the first wireless device to) transmit, to a second wireless device, a first transmission including a first transport block (TB) associated with a set of portions, where control information associated with the first transmission includes a resource reservation for the first transmission and at least one subsequent resource reservation. Based at least in part on information stored in the at least one memory, the at least one processor, individually or in any combination, is configured to receive, from the second wireless device, a hybrid automatic repeat request (HARQ) feedback indicating a decoding failure associated with at least one portion of the set of portions. Based at least in part on information stored in the at least one memory, the at least one processor, individually or in any combination, is configured to transmit, to the second wireless device, a second transmission based on the at least one subsequent resource reservation, where the second transmission includes the at least one portion of the set of portions associated with the first TB and at least a portion of a second TB.

In another aspect of the disclosure, a method, a computer-readable medium, and an apparatus at a second wireless device (e.g., a second UE or a network entity) are provided. The apparatus may include at least one memory and at least one processor coupled to the at least one memory. Based at least in part on information stored in the at least one memory, the at least one processor, individually or in any combination, is configured to receive, from a first wireless device, a first transmission including a first TB associated with a set of portions, where control information associated with the first transmission includes a resource reservation for the first transmission and at least one subsequent resource reservation. Based at least in part on information stored in the at least one memory, the at least one processor, individually or in any combination, is configured to transmit, to the first wireless device, a HARQ feedback indicating a decoding failure associated with at least one portion of the set of portions. Based at least in part on information stored in the at least one memory, the at least one processor, individually or in any combination, is configured to receive, from the first wireless device, a second transmission based on the at least one subsequent resource reservation, where the second transmission includes the at least one portion of the set of portions associated with the first TB and at least a portion of a second TB.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a first device and second device in an access network, in accordance with various aspects of the present disclosure.

FIG. 4 illustrates example aspects of a sidelink (SL) slot structure, in accordance with various aspects of the present disclosure.

FIG. 5 illustrates examples of resource reservation for sidelink communication, in accordance with various aspects of the present disclosure.

FIG. 6 is a diagram illustrating a timing diagram for a UE employing a sensing mechanism, in accordance with various aspects of the present disclosure.

FIG. 7 is a diagram illustrating an example of resource reservation for sidelink where two resources in future slots may be reserved for retransmissions, in accordance with various aspects of the present disclosure.

FIG. 8 is a diagram illustrating an example of resource reservation where one future resource is reserved for retransmission, in accordance with various aspects of the present disclosure.

FIG. 9 is a diagram illustrating example communications between a first wireless device and a second wireless device, in accordance with various aspects of the present disclosure.

FIG. 10 is a diagram illustrating example communications between a first wireless device that may be a first UE and a second wireless device that may be a second UE, in accordance with various aspects of the present disclosure.

FIG. 11 is a diagram illustrating retransmission(s) that may include code block groups (CBGs) from multiple TBs based on the CBG-based HARQ feedback, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an example apparatus and/or network entity, in accordance with various aspects of the present disclosure.

FIG. 17 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein enable portion-based hybrid automatic repeat request (HARQ) feedback based on portions of TB instead of entire TB which may be more adaptive and more resource efficient, resulting in potentially higher throughput. Based on aspects provided herein, a transmitting wireless device may multiplex data from a partially failed transport block (TB) (determined from a portion-based HARQ feedback of the original transmission) with data from a new TB in a single retransmission. Therefore, when the resources for retransmission are reserved upfront based on a fixed size, aspects provided herein may improve the resource efficiency in retransmissions.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

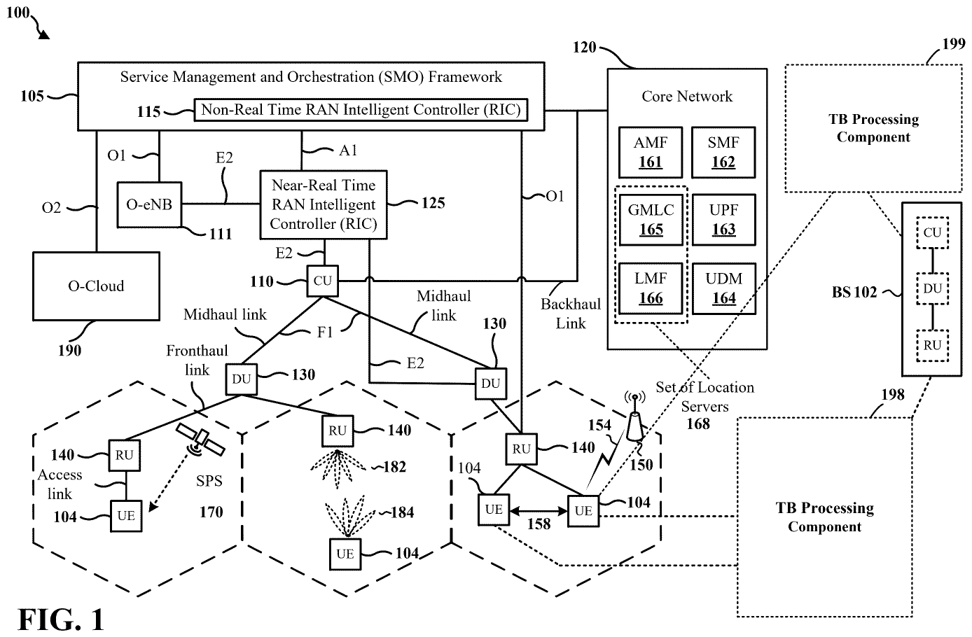

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, a first wireless device such as one of the UE 104 or the base station 102 may include a TB processing component 198. In some aspects, the TB processing component 198 may be configured to transmit, to a second wireless device, a first transmission including a first TB associated with a set of portions, where control information associated with the first transmission includes a resource reservation for the first transmission and at least one subsequent resource reservation (e.g., for retransmission of the first transmission). In some aspects, the TB processing component 198 may be further configured to receive, from the second wireless device, a HARQ feedback indicating a decoding failure associated with at least one portion of the set of portion. In some aspects, the TB processing component 198 may be further configured to transmit, to the second wireless device, a second transmission based on the at least one subsequent resource reservation, where the second transmission includes the at least one portion of the set of portion associated with the first TB and at least a portion of a second TB.

In certain aspects, a second wireless device such as one of the UE 104, another UE, or the base station 102 may include a TB processing component 199. In some aspects, the TB processing component 199 may be configured to receive, from a first wireless device, a first transmission including a first TB associated with a set of portions, where control information associated with the first transmission includes a resource reservation for the first transmission and at least one subsequent resource reservation. In some aspects, the TB processing component 199 may be further configured to transmit, to the first wireless device, a HARQ feedback indicating a decoding failure associated with at least one portion of the set of portion. In some aspects, the TB processing component 199 may be further configured to receive, from the first wireless device, a second transmission based on the at least one subsequent resource reservation, where the second transmission includes the at least one portion of the set of portion associated with the first TB and at least a portion of a second TB.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

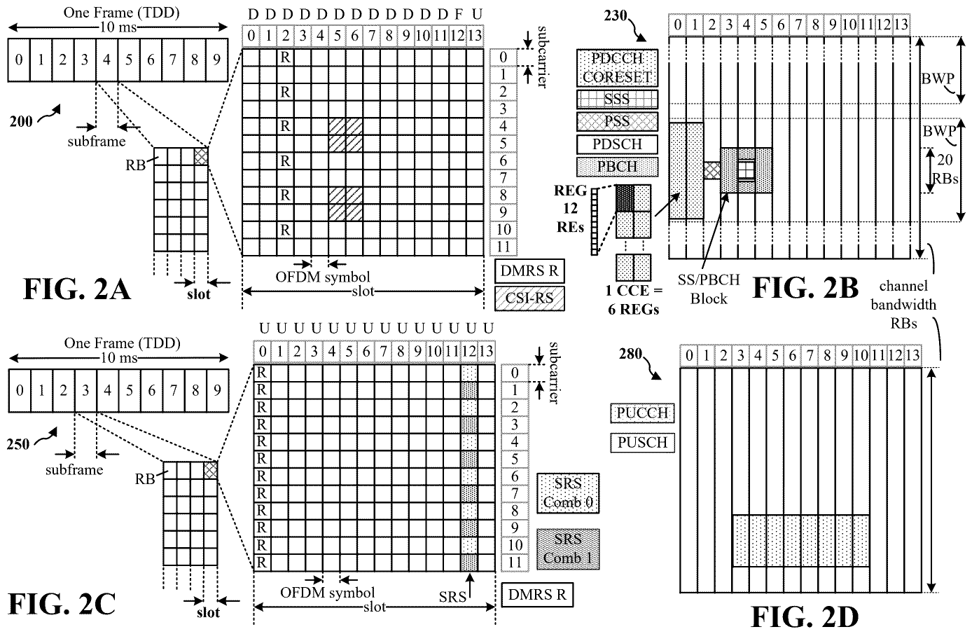

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

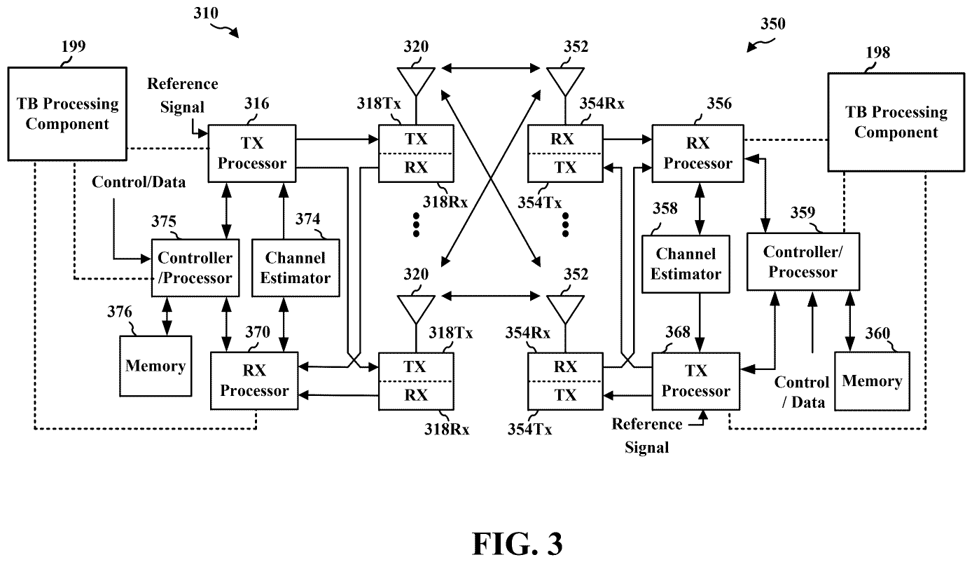

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate an RF carrier with a respective spatial stream for transmission.

At the device 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with TB processing component 198 of FIG. 1.

At least one of the TX processor 316, the RX processor 370, and the controller/processor 375 may be configured to perform aspects in connection with TB processing component 199 of FIG. 1.

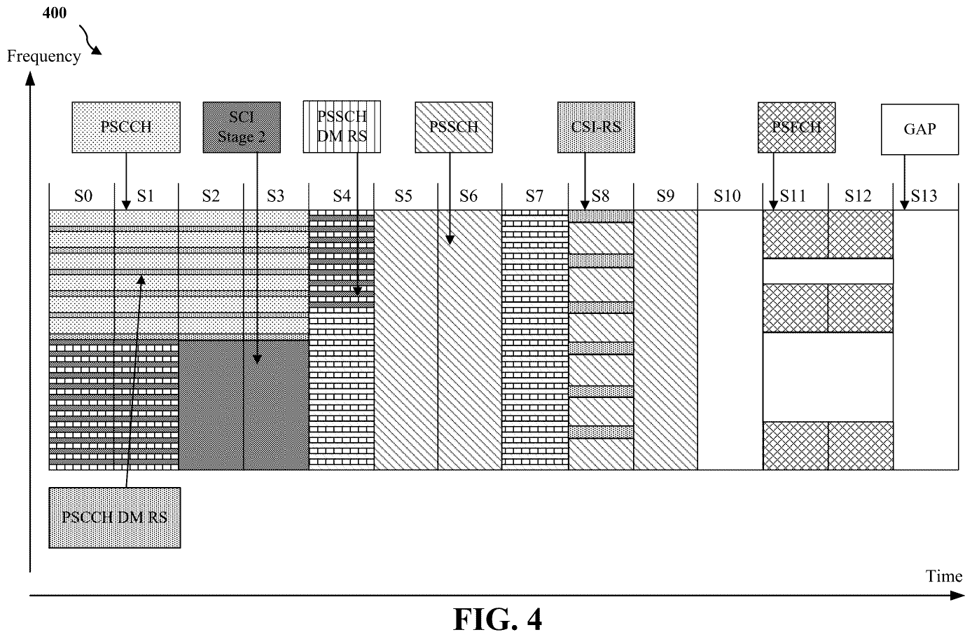

FIG. 4 includes diagram 400 illustrating example aspects of slot structures that may be used for sidelink communication (e.g., between UEs 104, a RSU, or the like). The slot structure may be within, or may use aspects of, a 5G/NR frame structure in some examples. As an example, NR CV2X may be based on an NR frame structure. In other examples, the slot structure may be within an LTE frame structure. As an example, LTE based CV2X may use an LTE frame structure in some aspects. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates an example sidelink transmission. A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The physical sidelink shared channel (PSSCH) occupies at least one subchannel. In some aspects, the PSCCH may include a first portion of sidelink control information (SCI) that may be referred to as SCI-1, and the PSSCH may include a second portion of SCI that may be referred to as SCI-2. The SCI may indicate information for a receiver to receive a data transmission in PSSCH. In some aspects, the SCI may indicate the resources on which the PSSCH will be transmitted. In such aspects, the SCI may be referred to as including a resource reservation.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation and coding scheme (MCS). The MCS may define how bits are mapped onto radio signals (e.g., QPSK, 16-QAM, 64-QAM, 256-QAM) and may define a coding rate. As illustrated in FIG. 4, some of the REs may include control information in PSCCH and some REs may include demodulation RS (DM-RS). There may be a 1:4 ratio between PSCCH and DM-RS associated with the PSCCH. There may be a 1:2 ratio between PSSCH and DM-RS associated with the PSSCH. At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DM-RS, SCI, feedback, gap symbols, and/or LBT symbols may be different than the example illustrated in FIG. 4. Multiple slots may be aggregated together in some aspects.

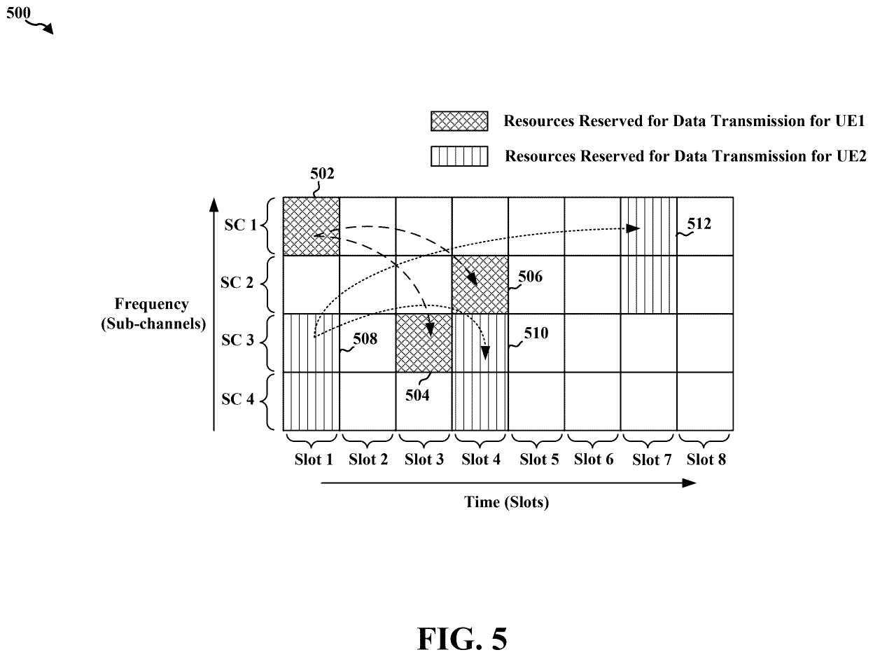

FIG. 5 is an example 500 of time and frequency resources showing reservations for sidelink transmissions, as presented herein. The resources may be included in a sidelink resource pool, for example. The resource allocation for each UE may be in units of one or more sub-channels in the frequency domain (e.g., sub-channels SC1 to SC 4), and may be based on one slot in the time domain (e.g., slots “1” to 8). The UE may also use resources in the current slot to perform an initial transmission, and may reserve resources in future slots for retransmissions. In the illustrated example of FIG. 5, two different future slots are being reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., a first data retransmission 504 and a second data retransmission 506). For example, the first UE may reserve sub-channels SC 3 at slot 3 and SC 2 at slot 4 for future retransmissions as shown by FIG. 5. The first UE then transmits information regarding which resources are being used and/or reserved by it to other UE(s). The first UE may do so by including the reservation information in a reservation resource field of the SCI, e.g., a first stage SCI.

FIG. 5 illustrates that a second UE (“UE2”) reserves resources in sub-channels SC 3 and SC 4 at slot “1” for a current data transmission 508, reserves a first data retransmission 510 at slot 4 using sub-channels SC 3 and SC 4, and reserves a second data retransmission 512 at slot 7 using sub-channels SC “1” and SC 2, as shown by FIG. 5. Similarly, the second UE may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for an initial transmission and a single transmission or only for an initial transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, the UE may determine a set of candidate resources (e.g., by monitoring SCI from other UEs and removing resources from the set of candidate resources that are reserved by other UEs in a signal for which the UE measures an RSRP above a threshold value). The UE may also select N resources for transmissions and/or retransmissions of a TB. As an example, the UE may randomly select the N resources from the set of candidate resources previously determined. For each transmission, the UE may reserve future time and frequency resources for an initial transmission and up to two retransmissions. The UE may reserve the resources by transmitting SCI indicating the resource reservation. For example, in the example in FIG. 5, the second UE may transmit SCI reserving resources for the current data transmission 508, the first data retransmission 510, and the second data retransmission 512.

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

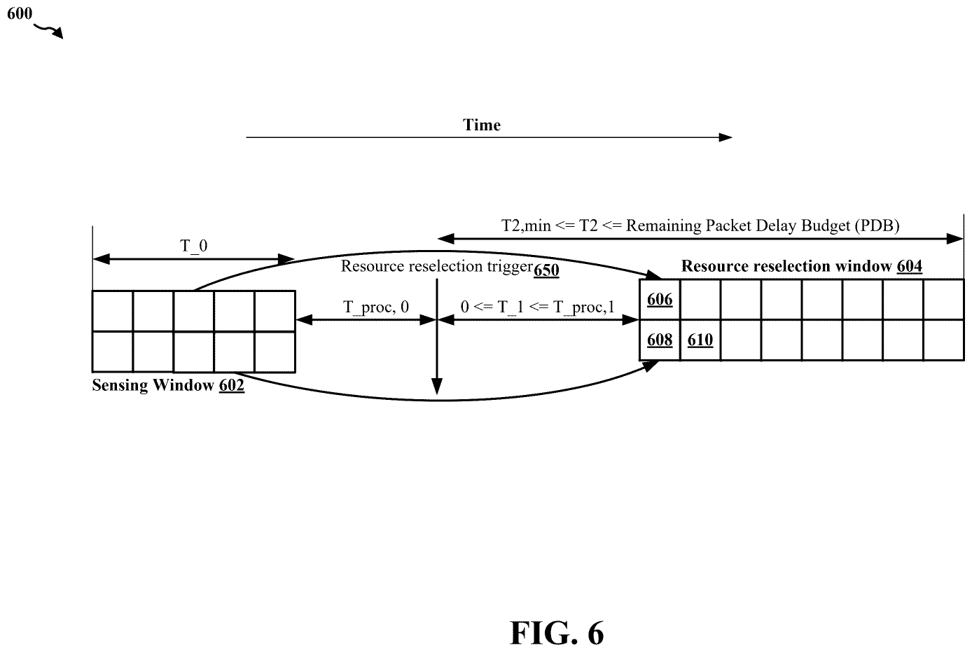

In the resource allocation Mode 2, a higher layer may request the UE 104 that includes the TB processing component 198 to determine a subset of resources from which the higher layer may select resources for PSSCH/PSCCH transmissions. FIG. 6 illustrates an example timing diagram 600 for a UE that may be triggered to select a resource for sidelink transmission in response to a resource selection trigger 650. The timing diagram shows a timing for sensing for resource reservations from other UEs, such as the resource reservations described in connection with FIG. 5. As an example, the resource selection trigger 650 may include having data for transmission. Although FIG. 6 is described in connection with a UE, the resource selection may also be applied by other sidelink devices. In response to the resource selection trigger 650, the UE may consider signals received within a sensing window 602 of duration T_0 and determine information (e.g., SCI with resource reservations) received within the sensing window 602. For example, the UE may determine which resources were used by other UE(s) or reserved by other UE(s) during the sensing window 602. The UE may anticipate that the previously used resources may also be used by the other UE in the future. A signal received in the sensing window may include SCI indicating a resource reservation for a resource within the resource selection window 604 following the resource selection trigger 650. Based on the past use of resources and/or the reservation of resources (e.g., the “sensing” of resources), the UE may determine which resources are scheduled for use and/or determine which resources are not scheduled for use. For example, based on the sensing of the resources during the sensing window 602, the UE may determine that a first resource 606 and a second resource 608 may be reserved during the slot associated with the resource selection trigger 650 and/or during a future slot. The UE may exclude candidate resources that are reserved by other UEs from a candidate set of resources when selecting a sidelink transmission resource. In some examples, the UE may exclude candidate resources that are reserved by another UE and that meet one or more conditions, such as the reservation signal meeting an RSRP threshold. The UE may select resource 610 for a transmission.

In some wireless communication systems, sidelink communication may be designed for V2X use cases. V2X communication may be for a UE (e.g., mounted on a vehicle) to connect with other UEs (other vehicles, vulnerable road users, or the like) in its vicinity for awareness of ego UE's presence/maneuver, which is more of a broadcast type communication in nature. For V2X, applications may generate relatively small payload (which may be also infrequent, e.g., >=100 ms packet arrival interval), as a result the throughput/capacity metrics may not be a priority. For distributed system (unlike cellular, which is centralized system), coordination of transmissions from transmitters may be important for mitigating conflict/interference from different transmitters, which may in turn render mechanisms that keep other transmitters informed of future resources usage (sidelink resource reservation and sensing) being useful. However, the HARQ feedback-based retransmission in some wireless communication systems may be non-adaptive, e.g., it is for a same TB with the same modulation and coding scheme (redundancy version (RV) may be different), and the retransmission may occur in a reserved resource (reserved via a previously sent SCI) that has the same bandwidth as the resource used for initial transmission. However, such per-TB retransmission based on non-adaptative HARQ feedback may be inefficient for throughput/capacity metrics because it may transmit an entirety of the same TB again even if a large portion of the TB is successfully decoded.

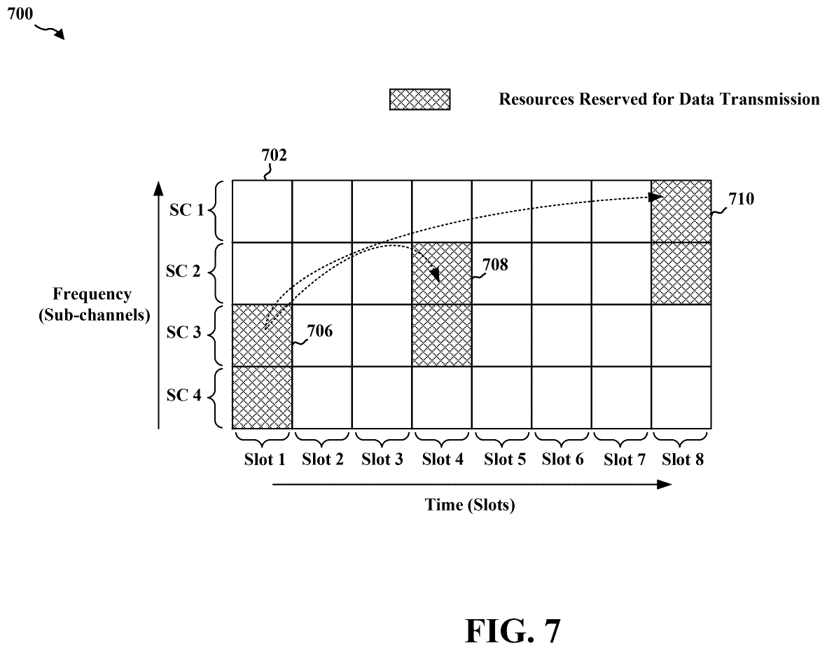

FIG. 7 is a diagram 700 illustrating an example of resource reservation for sidelink where two resources in future slots may be reserved for retransmissions, in accordance with various aspects of the present disclosure. As illustrated in FIG. 7, an SCI may reserve resources within a window 702 for an initial transmission and two subsequent transmissions. Resources 706 may be reserved for the initial transmission, resources 708 may be reserved for a first retransmission, and resources 710 may be reserved for a second retransmission. As illustrated in FIG. 7, a size of the resources 706, the resources 708, and the resource 710 may be the same (e.g., so that the retransmission may have enough resources even if the entirety of the TB has failed to be decoded by the receiving device).

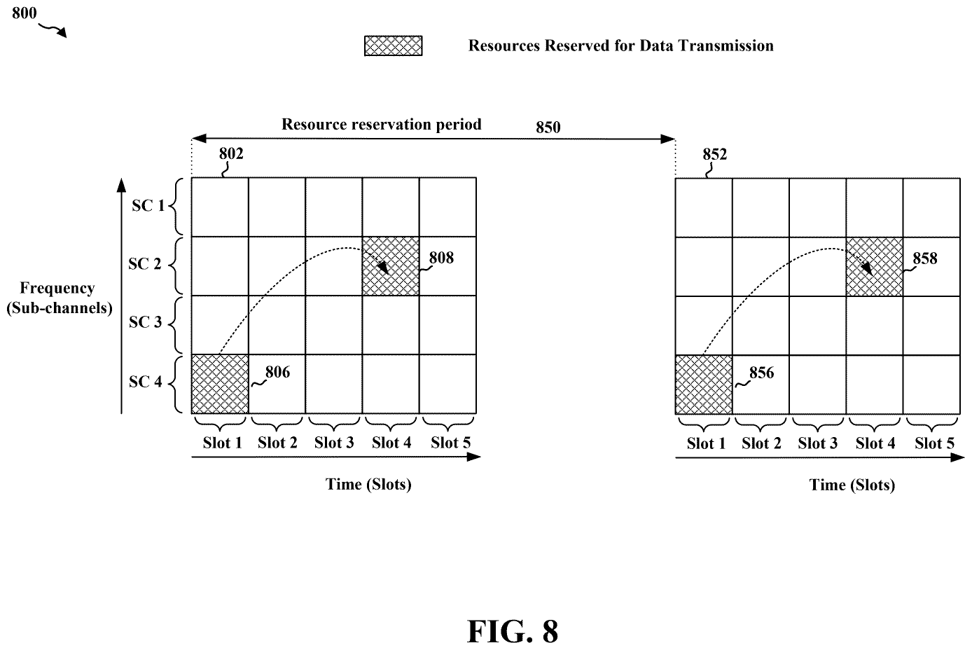

FIG. 8 is a diagram 800 illustrating an example of resource reservation where one future resource is reserved for retransmission, in accordance with various aspects of the present disclosure. As illustrated in FIG. 8, in a first time instance, an SCI may reserve resources within a window 802 for an initial transmission and a subsequent transmission. A resources 806 may be reserved for the initial transmission and a resources 808 may be reserved for a second retransmission. In a first time instance, an SCI may reserve resources within a window 852 for an initial transmission and a subsequent transmission. A resources 856 may be reserved for the initial transmission and a resources 858 may be reserved for a second retransmission. The time period between the first window 802 and the second window 852 may be the resource reservation period 850.

A “portion” of a TB may refer to a code block group (CBG), more than one CBG that may be further grouped, one or more code blocks (CBs), or an otherwise divided portion of a TB. Aspects provided herein enable portion-based, such as CBG-based hybrid automatic repeat request (HARQ) feedback that may be more adaptive and more resource efficient, resulting in potentially higher throughput. CBG-based HARQ is a HARQ retransmission mechanism that allows more granular retransmissions of TBs. A TB may include multiple portions (e.g., multiple CBGs) which may each include one or more CBs. In CBG-based HARQ, the receiving wireless device may report successful decoding associated with a portion of one or more CBGs of the TB and report decoding failure associated with another portion of one or more CBGs of the TB.

Based on aspects provided herein, a transmitting wireless device may multiplex data from a partially failed TB (determined from a CBG-based HARQ feedback of the original transmission) with data from a new TB in a single retransmission. Therefore, when the resources for retransmission are reserved upfront based on a fixed size, aspects provided herein may improve the resource efficiency in retransmissions.

For example, a Tx UE may multiplex data from a partially failed TB with data from a new TB for transmission in a single PSSCH. The data from the partially failed TB may be one or multiple of CBs from the failed TB, identified based on a received CBG-based HARQ feedback. The data from the new TB may include all CBs from the new TB, or a subset of CBs from the new TB. SL control signaling from the Tx UE may indicate or imply the multiplexing of retransmitted data and initially transmitted data in the same transmission, so the indented Rx UE may process the decoding accordingly. Aspects provided herein may improve resource efficiency by making full use of a reserved retransmission resource, while still retaining the feature of resource reservation in SL where reservation for retransmissions are performed upfront (e.g., for reliability). Based on aspects provided herein, a resource reservation may serve as a resource reservation for both retransmissions and new transmissions to allow flexibility and potentially reducing physical layer control signaling overhead and improve overall control signaling performance.

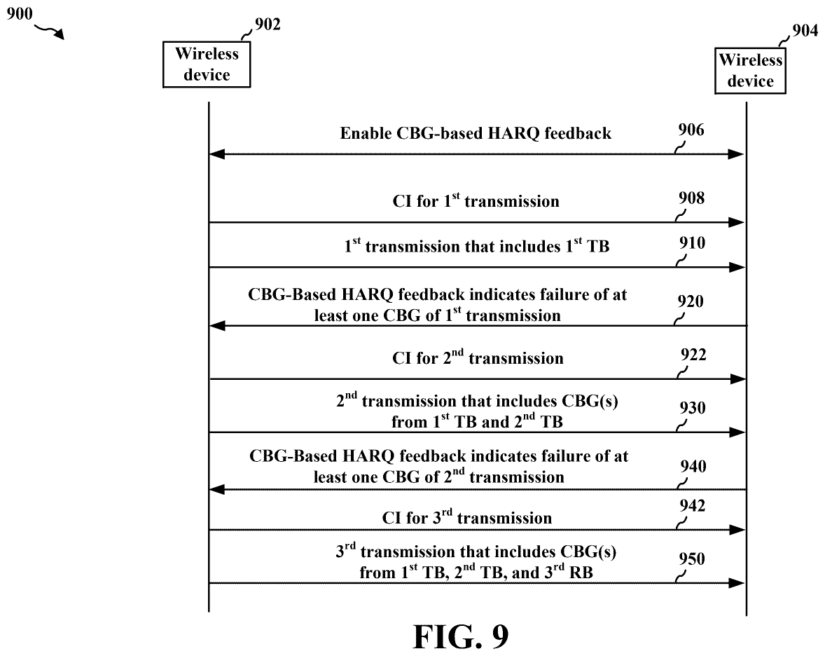

FIG. 9 is a diagram 900 illustrating example communications between a first wireless device 902 and a second wireless device 904, in accordance with various aspects of the present disclosure. As illustrated in FIG. 9, the first wireless device 902 and the second wireless device 904 may enable CBG-based HARQ feedback at 906. In some aspects, the CBG-based HARQ feedback is requested by the transmitting device, which is the first wireless device 902 (e.g., by indicating in control information 908 or separately requested). In some aspects, the CBG-based HARQ feedback is configured via RRC between the first wireless device 902 and the second wireless device 904. In some aspects, the CBG-based HARQ feedback is configured by the network or configured beforehand (e.g., via configuring HARQ feedback resources for CBG-based HARQ feedback).

In some aspects, while transmitting the first TB, the associated PHY control signaling (e.g., SCI) also indicates resource reservation for one or multiple of the first wireless device 902's next transmission regardless of whether it's a new transmission, a retransmission, or a mix of a retransmission of a previously transmitted TB and a new TB. As an example, the Tx UE may reserve a resource with the same frequency bandwidth (same number of PRBs/subchannels as its current transmission), in a future transmission occasion (slot) by indicating it in the control information. For example, the control information 908 may reserve resources for a first transmission 910 and two subsequent transmissions, the second transmission 930 and the third transmission 950. The first wireless device 902 may transmit the first transmission 910 that includes a first TB. In some aspects, the second wireless device 904 may transmit a CBG-based HARQ feedback 920 that indicates whether there is a decoding failure at a per-CBG level.

In some aspects, the second wireless device 904 may attempt to decode the first transmission 910 and generate CBG-based HARQ feedback for each CBG of the first TB. In some aspects, the second wireless device 904 may fail to decode a portion of the first TB, and the CBG-based HARQ feedback 920 may indicate a decoding failure (e.g., failure of passing a cyclic redundancy check (CRC) at the second wireless device 904) of at least one CBG of the first TB in the first transmission 910 and successful decode of a different portion of the first TB. Upon receiving the CBG-based HARQ feedback 920 that indicates a decoding failure of at least one CBG of the first TB in the first transmission 910, the first wireless device 902 may multiplex the at least one CBG of the first TB in the first transmission 910 and data from a second TB (e.g., an entirety of a second TB or a portion of a second TB) as a single transmission in the previously reserved resources.

The first wireless device 902 may transmit the second transmission 930 (based on resources reserved by the control information 908) which includes the at least one CBG of the first TB in the first transmission 910 and data from a second TB (e.g., an entirety of a second TB or a portion of a second TB). In some aspects, if the CBG-based HARQ feedback 920 indicates no decoding failure, the first wireless device 902 may transmit the second transmission 930 (based on resources reserved by the control information 908) which includes the second TB without CBG of the first TB.

In some aspects, control information 922 associated with the second transmission 930 may indicate or imply that the second transmission 930 includes multiplexing of new data with retransmitted data. The second wireless device may decode the second transmission 930 based on the control information 922 that may indicate or imply that the second transmission 930 includes multiplexing of new data with retransmitted data.

In some aspects, the second wireless device 904 may transmit a CBG-based HARQ feedback 940 that indicates whether there is a decoding failure at a per-CBG level associated with the second transmission 930.

In some aspects, the second wireless device 904 may attempt to decode the second transmission 930 and generate CBG-based HARQ feedback for each CBG of the first TB and the second TB in the second transmission 930. In some aspects, the second wireless device 904 may fail to decode a portion of the second transmission 930, and the CBG-based HARQ feedback 940 may indicate a decoding failure (e.g., failure of passing a cyclic redundancy check (CRC) at the second wireless device 904) of at least one CBG of the first TB and the second TB in the second transmission 930 and successful decode of a different portion of the first TB. Upon receiving the CBG-based HARQ feedback 920 that indicates a decoding failure of at least one CBG of the first TB in the first transmission 910, the first wireless device 902 may multiplex the at least one CBG of the first TB in the first transmission 910 and data from a second TB (e.g., an entirety of a second TB or a portion of a second TB) as a single transmission in the previously reserved resources.

The first wireless device 902 may transmit the third transmission 950 (based on resources reserved by the control information 908) which includes the at least one CBG of the first TB or the second TB in the second transmission 930 and data from a third TB (e.g., an entirety of a third TB or a portion of a third TB) or a rest of the second TB. In some aspects, if the CBG-based HARQ feedback 940 indicates no decoding failure, the first wireless device 902 may transmit the third transmission 950 (based on resources reserved by the control information 908) which includes the third TB without CBG of the first TB or the second TB.

In some aspects, control information 942 associated with the third transmission 950 may indicate or imply that the third transmission 950 includes multiplexing of new data with retransmitted data. The second wireless device 904 may decode the third transmission 950 based on the control information 942 that may indicate or imply that the third transmission 950 includes multiplexing of new data with retransmitted data.

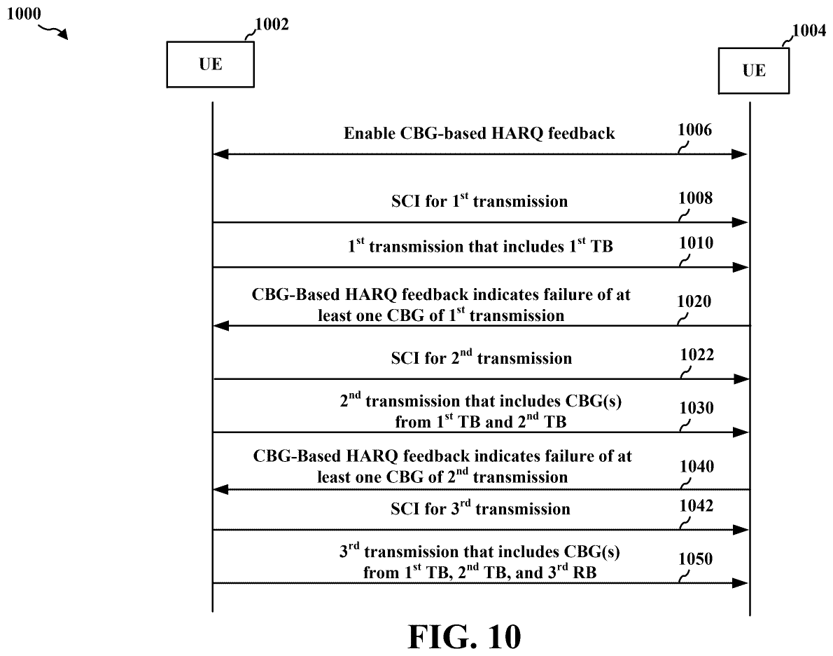

FIG. 10 is a diagram 1000 illustrating example communications between a first wireless device 1002 that may be a first UE and a second wireless device 1004 that may be a second UE, in accordance with various aspects of the present disclosure. As illustrated in FIG. 10, the first wireless device 1002 and the second wireless device 1004 may enable CBG-based HARQ feedback at 1006. In some aspects, the CBG-based HARQ feedback is requested by the Tx UE, which is the first wireless device 1002 (e.g., by indicating in SCI 1008 or separately requested). In some aspects, the CBG-based HARQ feedback is configured via SL RRC between the first wireless device 1002 and the second wireless device 1004. In some aspects, the CBG-based HARQ feedback is configured by the network or configured beforehand (e.g., via configuring HARQ feedback resources for CBG-based HARQ feedback).

In some aspects, while transmitting the first TB, the associated PHY control signaling (e.g., SCI) also indicates resource reservation for one or multiple of the first wireless device 1002's next transmission regardless of whether it's a new transmission, a retransmission, or a mix of a retransmission of a previously transmitted TB and a new TB. As an example, the Tx UE may reserve a resource with the same frequency bandwidth (same number of PRBs/subchannels as its current transmission), in a future transmission occasion (slot) by indicating it in the SC. For example, the SCI 1008 may reserve resources for a first transmission 1010 and two subsequent transmissions, the second transmission 1030 and the third transmission 1050, which may be PSSCH transmissions. The first wireless device 1002 may transmit the first transmission 1010 that includes a first TB. In some aspects, the second wireless device 1004 may transmit a CBG-based HARQ feedback 1020 that indicates whether there is a decoding failure at a per-CBG level.

In some aspects, the second wireless device 1004 may attempt to decode the first transmission 1010 and generate CBG-based HARQ feedback for each CBG of the first TB. In some aspects, the second wireless device 1004 may fail to decode a portion of the first TB, and the CBG-based HARQ feedback 1020 may indicate a decoding failure (e.g., failure of passing a cyclic redundancy check (CRC) at the second wireless device 1004) of at least one CBG of the first TB in the first transmission 1010 and successful decode of a different portion of the first TB. Upon receiving the CBG-based HARQ feedback 1020 that indicates a decoding failure of at least one CBG of the first TB in the first transmission 1010, the first wireless device 1002 may multiplex the at least one CBG of the first TB in the first transmission 1010 and data from a second TB (e.g., an entirety of a second TB or a portion of a second TB) as a single transmission in the previously reserved resources.

The first wireless device 1002 may transmit the second transmission 1030 (based on resources reserved by the SCI 1008) which includes the at least one CBG of the first TB in the first transmission 1010 and data from a second TB (e.g., an entirety of a second TB or a portion of a second TB). In some aspects, if the CBG-based HARQ feedback 1020 indicates no decoding failure, the first wireless device 1002 may transmit the second transmission 1030 (based on resources reserved by the SCI 1008) which includes the second TB without CBG of the first TB.

In some aspects, SCI 1022 associated with the second transmission 1030 may indicate or imply that the second transmission 1030 includes multiplexing of new data with retransmitted data. The second wireless device may decode the second transmission 1030 based on the SCI 1022 that may indicate or imply that the second transmission 1030 includes multiplexing of new data with retransmitted data.

In some aspects, the second wireless device 1004 may transmit a CBG-based HARQ feedback 1040 that indicates whether there is a decoding failure at a per-CBG level associated with the second transmission 1030.

In some aspects, the second wireless device 1004 may attempt to decode the second transmission 1030 and generate CBG-based HARQ feedback for each CBG of the first TB and the second TB in the second transmission 1030. In some aspects, the second wireless device 1004 may fail to decode a portion of the second transmission 1030, and the CBG-based HARQ feedback 1040 may indicate a decoding failure (e.g., failure of passing a cyclic redundancy check (CRC) at the second wireless device 1004) of at least one CBG of the first TB and the second TB in the second transmission 1030 and successful decode of a different portion of the first TB. Upon receiving the CBG-based HARQ feedback 1020 that indicates a decoding failure of at least one CBG of the first TB in the first transmission 1010, the first wireless device 1002 may multiplex the at least one CBG of the first TB in the first transmission 1010 and data from a second TB (e.g., an entirety of a second TB or a portion of a second TB) as a single transmission in the previously reserved resources.

The first wireless device 1002 may transmit the third transmission 1050 (based on resources reserved by the SCI 1008) which includes the at least one CBG of the first TB or the second TB in the second transmission 1030 and data from a third TB (e.g., an entirety of a third TB or a portion of a third TB) or a rest of the second TB. In some aspects, if the CBG-based HARQ feedback 1040 indicates no decoding failure, the first wireless device 1002 may transmit the third transmission 1050 (based on resources reserved by the SCI 1008) which includes the third TB without CBG of the first TB or the second TB.

In some aspects, SCI 1042 associated with the third transmission 1050 may indicate or imply that the third transmission 1050 includes multiplexing of new data with retransmitted data. The second wireless device 1004 may decode the third transmission 1050 based on the SCI 1042 that may indicate or imply that the third transmission 1050 includes multiplexing of new data with retransmitted data.

In some aspects, when retransmission of failed CBG(s) and initial transmission of new CBG(s) are multiplexed in the same PSSCH, the same MCS may be used for multiplexed transmission of CBG(s) to reduce signaling overhead. In other words, a same MCS may be used for an entirety of the second transmission 930 or the second transmission 1030 and an entirety of the third transmission 950 or the third transmission 1050. The MCS used for the subsequent transmission(s) may be different or the same as the first transmission (e.g., 910 or 1010). In some aspects, the Tx wireless device (e.g., 902 or 1002) may determine the MCS and indicate it in control information (e.g., SCI) (e.g., 922, 1022, 942, 1042) associated with the multiplexed transmission of the CBG(s). Such aspects may allow more flexibility for Tx UE scheduling. Accordingly, TB size determination for the new TB may be performed based on the MCS determined by the Tx wireless device, which may be different from or same as the MCS used in the first transmission. In some aspects, the MCS for the subsequent transmission(s) may be the same as the first transmission and non-adaptative. Accordingly, TB size determination for the new TB is performed based on the MCS that was used in the first transmission. Whether the MCS is adaptive or not may be configured by the network or configured between the first wireless device and the second wireless device.

In some aspects, TB size for the new TB to be (partially) multiplexed with failed CBG(s) of the previous TB may be determined based on the MCS that would be used for the multiplexed transmission. In some aspects, TB size determination for the new TB is performed based on the reserved resource(s) that would be available for the new TB transmission. In other words, the TB size determination may be based on the assumption that all resource of the reservation would be used for a new TB (without accounting for potential retransmission of part of a previous TB), which may result in a portion of the new TB being left out of the transmission (and may go into the next transmission). For example, a part of CBGs from the new TB may be fit into PSSCH for the multiplexed transmission. If the MCS remains the same in the first transmission and the subsequent transmissions, the TB size may be the same.

In some aspects, a TB size for the new TB to be multiplexed with failed CBG(s) of the previous TB may be determined while taking into account the multiplexing with retransmission of failed CBG(s) is enabled (e.g., same TB size may be a condition for multiplexing). For example, if the first TB was segmented into 6 CBGs and the first 2 CBGs were failed in decoding, the second TB may be multiplexed with first 4 CBGs from the new TB (same TB size thus same number of CBGs) and are transmitted in a single PSSCH in the reserved resource(s).

In some aspects, TB size determination for the new TB is performed assuming a portion of the reserved resource may be available for the new TB transmission (e.g., and exclude the resources that would be used for the retransmission). In other words, when performing TB size determination, the resource that would be taken by retransmission of failed CBG(s) of the previous TB are excluded; the remaining resource in the reserved resource would then be used for TB size determination of the new TB. Therefore, TB size for the new TB may be different from the first TB, and the multiplexed transmission may include a complete TB (new TB) and failed CBG(s) from the previous transmission. For example, if MCSs for the first transmission and the second transmission are the same, there may be a scale number of available REs used for new TB size determination based on ratio of succeeded CBG(s). If the previous transmission has 6 CBGs and 2 out of 6 were failed in decoding, the TB size determination for the new TB may assume 4 out of 6 of the REs (used in the previous TB size determination or total available REs in current reserved resource) are available for determining size of the new TB. In some aspects, MCS for subsequent transmission in the reserved resource may remain the same or be different from the previous transmission. The UE may determine number of REs that may be excluded for new TB size determination, which may be based on the MCS for the multiplexed transmission and number of information bits in the retransmitted CBG(s). For example, if 2 out of 6 CBGs failed and there are 2 CBs per CBG and if the CB size is X (including or excluding CB CRC), and MCS is 64QAM (6 bits per symbol) with code rate 0.8 for the multiplexed transmission and a single layer is used; the number of excluded REs in new TB size determination may be 2*2*X/0.8/6.

In some aspects, to mitigate potential error in transmission of HARQ feedback, there may be indication in control information for the multiplexing of CBGs from different TBs. For example, there may be a “CBG Transmission Information” in SCI, which may be a bitmap with one bit corresponding to one CBG, to indicate whether the corresponding CBG of the previous transmission is being retransmitted or not. For example, if the previous transmission had 6 CBGs, then 6 bits may be used to indicate which CBGs from the previous transmission are being retransmitted in this transmission. Together with new data indicator (NDI), these fields may indicate or imply whether new data from another TB is being multiplexed. For example, a toggled NDI implies that the retransmitted CBGs (being indicated by that parameter) in a previous transmission are being multiplexed with new data in the current transmission and a non-toggled NDI implies no multiplexing of new data in the current transmission. In some aspects, the HARQ process number may remain the same for the multiplexed transmission(s).

As an example, if all CBGs in the previous transmission would be retransmitted (e.g., there was no CBG decoded successfully in the previous transmission), the bitmap in SCI associated with transmission in the reserved resource may indicate every CBG in the previous transmission is being retransmitted and NDI may be not toggled. As another example, if no CBG in the previous transmission would be retransmitted, the reserved resource associated with control information of the previous transmission may be used for transmission of a new TB. In such cases, in some aspects, the wireless device may use a different HARQ process number for transmission in the reserved resource (to imply that this is initial transmission of something new without retransmission). In some aspects, the wireless device may use a same HARQ process number for transmission in the reserved resource because the reserved resource associated with control information of the previous transmission is being used. In some aspects, the wireless device may choose to use the same or different HARQ process number, as combination of the bitmap and NDI can be used to identify the case of no CBG being retransmitted/transmitting a new TB.

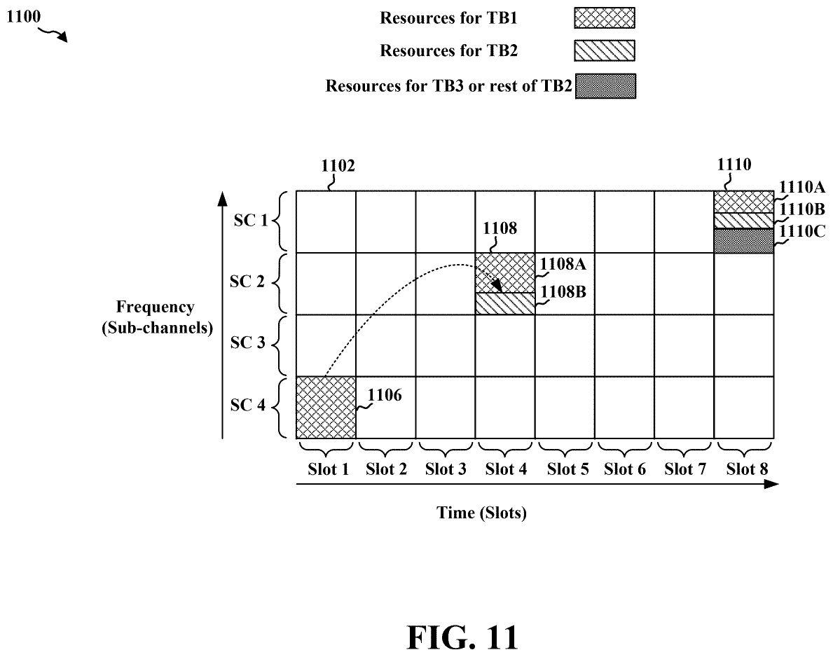

FIG. 11 is a diagram 1100 illustrating retransmission(s) that may include CBGs from multiple TBs based on the CBG-based HARQ feedback, in accordance with various aspects of the present disclosure. As illustrated in FIG. 11, an SCI may reserve, within a time period 1102, resources 1106 for a first transmission, resources 1108 for a second transmission, and resources 1110 for a third transmission. The resources 1106 for the first transmission may be used to carry a first TB. Based on CBG-based HARQ feedback that a portion of the first TB is not successfully decoded, a first portion 1108A of the resources 1108 for the second transmission may be used for carrying the portion of the first TB that was not successfully decoded and a second portion 1108B may be used for carrying a second TB or a portion of a second TB. In some aspects, based on CBG-based HARQ feedback that a portion of the second transmission is not successfully decoded, a first portion 1110A of the resources 1110 for the third transmission may be used for carrying a portion of the first TB that was not successfully decoded in the second transmission, a second portion 1110B may be used for carrying a portion of the second TB that was not successfully decoded in the second transmission, and a third portion 1110C may be used for carrying a third TB or a rest of the second TB that was not previously transmitted.

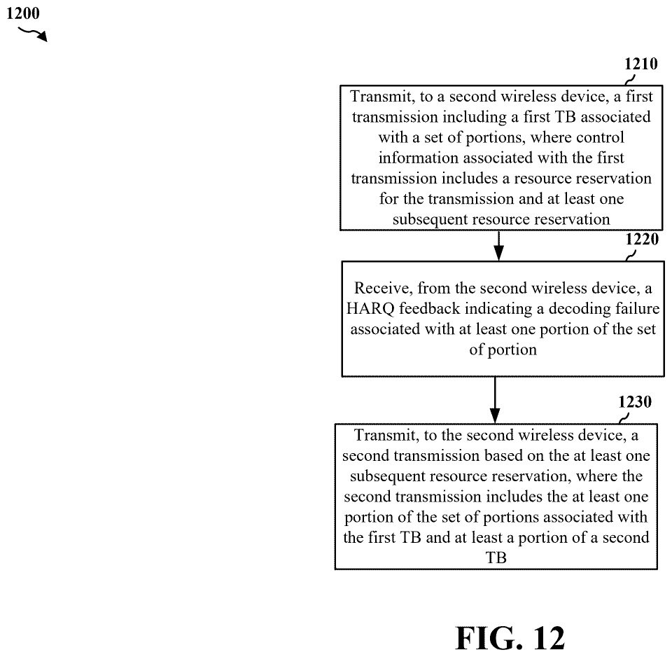

FIG. 12 is a flowchart 1200 of a method of wireless communication. The method may be performed by a first wireless device (e.g., the UE 104, the base station 102, the first wireless device 902, the first wireless device 1002; the apparatus 1604). The method may enable CBG-based HARQ feedback and a retransmission that may include CBGs from multiple TBs based on the CBG-based HARQ feedback, which improves overall resource efficiency for retransmissions.

At 1210, the first wireless device may transmit, to a second wireless device, a first transmission including a first TB associated with a set of portions, where control information associated with the first transmission includes a resource reservation for the first transmission and at least one subsequent resource reservation. For example, the first wireless device (e.g., 902 or 1002) may transmit, to a second wireless device (e.g., 904 or 1004), a first transmission (e.g., 910 or 1010) including a first TB associated with a set of portions, where control information associated with the first transmission includes a resource reservation for the first transmission and at least one subsequent resource reservation. In some aspects, 1202 may be performed by TB processing component 198.

At 1220, the first wireless device may receive, from the second wireless device, a HARQ feedback indicating a decoding failure associated with at least one portion of the set of portion. For example, the first wireless device (e.g., 902 or 1002) may receive, from the second wireless device (e.g., 904 or 1004), a HARQ feedback (e.g., 920 or 1020) indicating a decoding failure associated with at least one portion of the set of portion. In some aspects, 1220 may be performed by TB processing component 198.

At 1230, the first wireless device may transmit, to the second wireless device, a second transmission based on the at least one subsequent resource reservation, where the second transmission includes the at least one portion of the set of portion associated with the first TB and at least a portion of a second TB. For example, the first wireless device (e.g., 902 or 1002) may transmit, to the second wireless device (e.g., 904 or 1004), a second transmission (e.g., 930 or 1030) based on the at least one subsequent resource reservation, where the second transmission includes the at least one portion of the set of portion associated with the first TB and at least a portion of a second TB. In some aspects, 1230 may be performed by TB processing component 198.

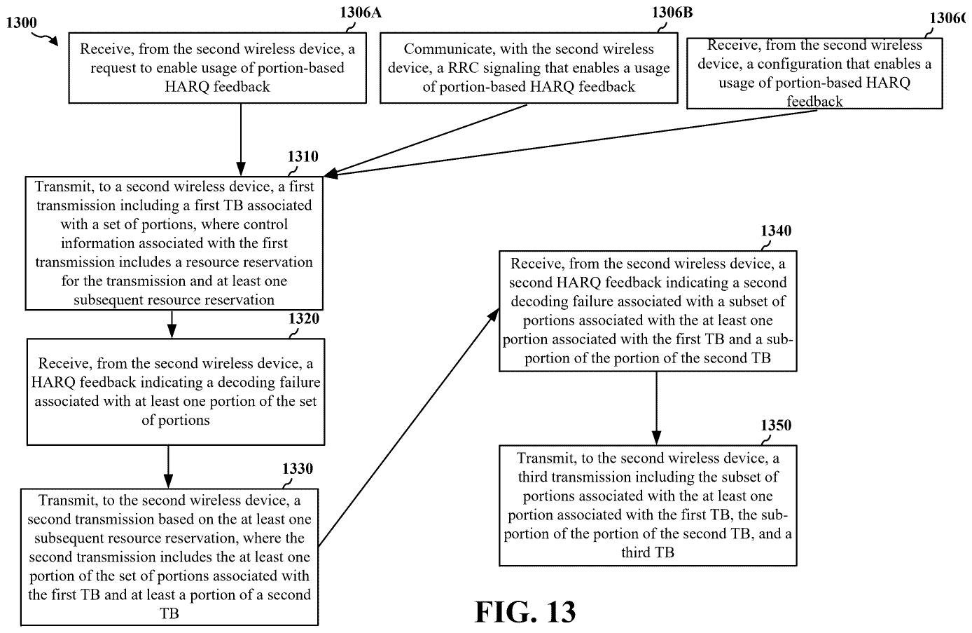

FIG. 13 is a flowchart 1300 of a method of wireless communication. The method may be performed by a first wireless device (e.g., the UE 104, the base station 102, the first wireless device 902, the first wireless device 1002; the apparatus 1604). The method may enable portion-based HARQ feedback and a retransmission that may include CBGs from multiple TBs based on the portion-based HARQ feedback, which improves overall resource efficiency for retransmissions.

At 1310, the first wireless device may transmit, to a second wireless device, a first transmission including a first TB associated with a set of portions, where control information associated with the first transmission includes a resource reservation for the first transmission and at least one subsequent resource reservation. For example, the first wireless device (e.g., 902 or 1002) may transmit, to a second wireless device (e.g., 904 or 1004), a first transmission (e.g., 910 or 1010) including a first TB associated with a set of portions, where control information associated with the first transmission includes a resource reservation for the first transmission and at least one subsequent resource reservation. In some aspects, 1302 may be performed by TB processing component 198.

At 1320, the first wireless device may receive, from the second wireless device, a HARQ feedback indicating a decoding failure associated with at least one portion of the set of portion. For example, the first wireless device (e.g., 902 or 1002) may receive, from the second wireless device (e.g., 904 or 1004), a HARQ feedback (e.g., 920 or 1020) indicating a decoding failure associated with at least one portion of the set of portion. In some aspects, 1320 may be performed by TB processing component 198.

At 1330, the first wireless device may transmit, to the second wireless device, a second transmission based on the at least one subsequent resource reservation, where the second transmission includes the at least one portion of the set of portion associated with the first TB and at least a portion of a second TB. For example, the first wireless device (e.g., 902 or 1002) may transmit, to the second wireless device (e.g., 904 or 1004), a second transmission (e.g., 930 or 1030) based on the at least one subsequent resource reservation, where the second transmission includes the at least one portion of the set of portion associated with the first TB and at least a portion of a second TB. In some aspects, 1330 may be performed by TB processing component 198.

At 1330, the first wireless device may transmit, to the second wireless device, a second transmission based on the at least one subsequent resource reservation, where the second transmission includes the at least one portion of the set of portion associated with the first TB and at least a portion of a second TB. For example, the first wireless device (e.g., 902 or 1002) may transmit, to the second wireless device (e.g., 904 or 1004), a second transmission (e.g., 930 or 1030) based on the at least one subsequent resource reservation, where the second transmission includes the at least one portion of the set of portion associated with the first TB and at least a portion of a second TB. In some aspects, 1330 may be performed by TB processing component 198.

At 1306A, the first wireless device may receive, from the second wireless device, a request to enable usage of portion-based HARQ feedback. For example, the first wireless device (e.g., 902 or 1002) may receive, from the second wireless device, a request to enable usage of portion-based HARQ feedback. In some aspects, 1306A may be performed by TB processing component 198.

At 1306B, the first wireless device may communicate, with the second wireless device, a RRC signaling that enables a usage of portion-based HARQ feedback. For example, the first wireless device (e.g., 902 or 1002) may communicate, with the second wireless device, a RRC signaling that enables a usage of portion-based HARQ feedback. In some aspects, 1306B may be performed by TB processing component 198.

At 1306C, the first wireless device may receive, from the second wireless device, a configuration that enables a usage of portion-based HARQ feedback. For example, the first wireless device (e.g., 902 or 1002) may receive, from the second wireless device, a configuration that enables a usage of portion-based HARQ feedback. In some aspects, 1306C may be performed by TB processing component 198.

In some aspects, the resource reservation indicates a first set of PRBs or a first set of subchannels for the first transmission, where the at least one subsequent resource reservation indicates a second set of PRBs or a second set of subchannels for the second transmission, and where the first set of PRBs or the first set of subchannels is associated with a same quantity as the second set of PRBs or the second set of subchannels. In some aspects, the first transmission is associated with a modulation and coding scheme (MCS), and where the second transmission is associated with the MCS. In some aspects, the first transmission is associated with a first MCS, and where the second transmission is associated with a second MCS. In some aspects, the first wireless device may transmit, to the second wireless device, second control information (e.g., 922 or 1022) associated with the second transmission, where the second control information indicates that the second transmission is associated with the first TB and the second TB.

At 1340, the first wireless device may receive, from the second wireless device, a second HARQ feedback indicating a second decoding failure associated with a subset of portions associated with the at least one portion associated with the first TB and a sub-portion of the portion of the second TB. For example, the first wireless device (e.g., 902 or 1002) may receive, from the second wireless device, a second HARQ feedback (e.g., 940 or 1040) indicating a second decoding failure associated with a subset of portions associated with the at least one portion associated with the first TB and a sub-portion of the portion of the second TB. In some aspects, 1340 may be performed by TB processing component 198.

At 1350, the first wireless device may transmit, to the second wireless device, a third transmission including the subset of portions associated with the at least one portion associated with the first TB, the sub-portion of the portion of the second TB, and a third TB. For example, the first wireless device (e.g., 902 or 1002) may transmit, to the second wireless device, a third transmission (e.g., 950 or 1050) including the subset of portions associated with the at least one portion associated with the first TB, the sub-portion of the portion of the second TB, and a third TB. In some aspects, 1350 may be performed by TB processing component 198.

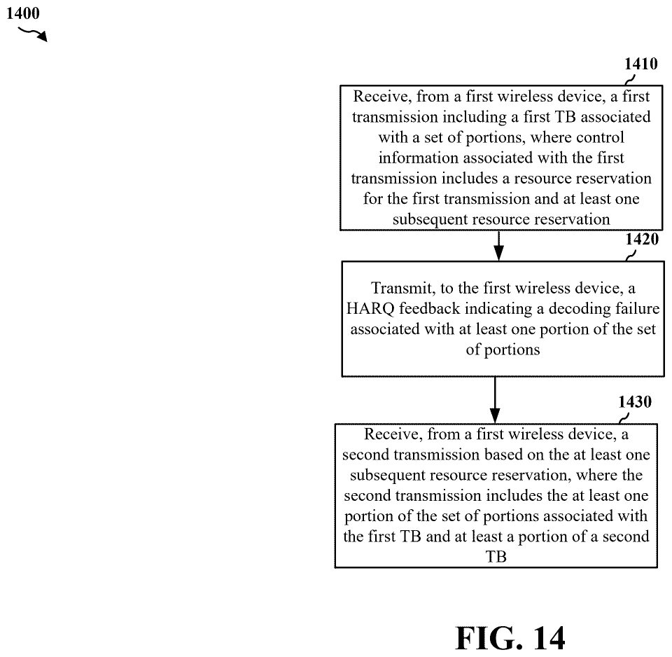

FIG. 14 is a flowchart 1400 of a method of wireless communication. The method may be performed by a second wireless device (e.g., the UE 104, the base station 102, the second wireless device 904, the second wireless device 1004; the apparatus 1604). The method may enable portion-based HARQ feedback and a retransmission that may include CBGs from multiple TBs based on the portion-based HARQ feedback, which improves overall resource efficiency for retransmissions.

At 1410, the second wireless device may receive, from a first wireless device, a first transmission including a first TB associated with a set of portions, where control information associated with the first transmission includes a resource reservation for the first transmission and at least one subsequent resource reservation. For example, the second wireless device (e.g., 904 or 1004) may receive, from a first wireless device (e.g., 902 or 1002), a first transmission (e.g., 910 or 1010) including a first TB associated with a set of portions, where control information associated with the first transmission includes a resource reservation for the first transmission and at least one subsequent resource reservation. In some aspects, 1402 may be performed by TB processing component 198.

At 1420, the second wireless device may transmit, to the first wireless device, a HARQ feedback indicating a decoding failure associated with at least one portion of the set of portion. For example, the second wireless device (e.g., 904 or 1004) may transmit, to the first wireless device (e.g., 902 or 1002), a HARQ feedback (e.g., 920 or 1020) indicating a decoding failure associated with at least one portion of the set of portion. In some aspects, 1420 may be performed by TB processing component 198.

At 1430, the second wireless device may receive, from the first wireless device, a second transmission based on the at least one subsequent resource reservation, where the second transmission includes the at least one portion of the set of portion associated with the first TB and at least a portion of a second TB. For example, the second wireless device (e.g., 904 or 1004) may receive, from the first wireless device (e.g., 902 or 1002), a second transmission (e.g., 930 or 1030) based on the at least one subsequent resource reservation, where the second transmission includes the at least one portion of the set of portion associated with the first TB and at least a portion of a second TB. In some aspects, 1430 may be performed by TB processing component 198.

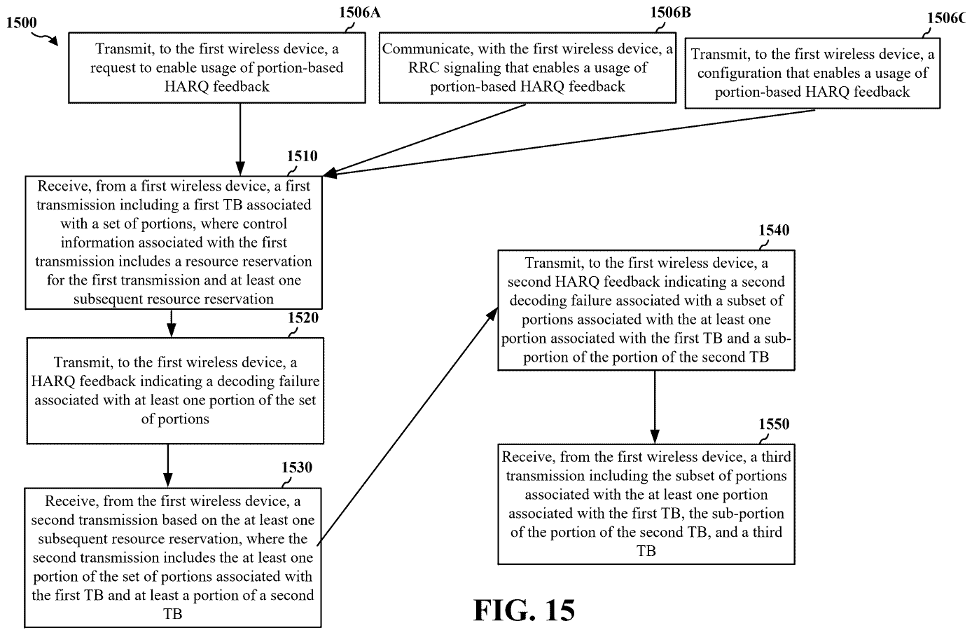

FIG. 15 is a flowchart 1500 of a method of wireless communication. The method may be performed by a second wireless device (e.g., the UE 104, the base station 102, the second wireless device 904, the second wireless device 1004; the apparatus 1604). The method may enable portion-based HARQ feedback and a retransmission that may include CBGs from multiple TBs based on the portion-based HARQ feedback, which improves overall resource efficiency for retransmissions.

At 1510, the second wireless device may receive, from a first wireless device, a first transmission including a first TB associated with a set of portions, where control information associated with the first transmission includes a resource reservation for the first transmission and at least one subsequent resource reservation. For example, the second wireless device (e.g., 904 or 1004) may receive, from a first wireless device (e.g., 902 or 1002), a first transmission (e.g., 910 or 1010) including a first TB associated with a set of portions, where control information associated with the first transmission includes a resource reservation for the first transmission and at least one subsequent resource reservation. In some aspects, 1502 may be performed by TB processing component 198.

At 1520, the second wireless device may transmit, to the first wireless device, a HARQ feedback indicating a decoding failure associated with at least one portion of the set of portion. For example, the second wireless device (e.g., 904 or 1004) may transmit, to the first wireless device (e.g., 902 or 1002), a HARQ feedback (e.g., 920 or 1020) indicating a decoding failure associated with at least one portion of the set of portion. In some aspects, 1520 may be performed by TB processing component 198.

At 1530, the second wireless device may receive, from the first wireless device, a second transmission based on the at least one subsequent resource reservation, where the second transmission includes the at least one portion of the set of portion associated with the first TB and at least a portion of a second TB. For example, the second wireless device (e.g., 904 or 1004) may receive, from the first wireless device (e.g., 902 or 1002), a second transmission (e.g., 930 or 1030) based on the at least one subsequent resource reservation, where the second transmission includes the at least one portion of the set of portion associated with the first TB and at least a portion of a second TB. In some aspects, 1530 may be performed by TB processing component 198.

At 1530, the second wireless device may receive, from the first wireless device, a second transmission based on the at least one subsequent resource reservation, where the second transmission includes the at least one portion of the set of portion associated with the first TB and at least a portion of a second TB. For example, the second wireless device (e.g., 904 or 1004) may receive, from the first wireless device (e.g., 902 or 1002), a second transmission (e.g., 930 or 1030) based on the at least one subsequent resource reservation, where the second transmission includes the at least one portion of the set of portion associated with the first TB and at least a portion of a second TB. In some aspects, 1530 may be performed by TB processing component 198.

At 1506A, the second wireless device may transmit, to the first wireless device, a request to enable usage of portion-based HARQ feedback. For example, the second wireless device (e.g., 904 or 1004) may transmit, to the first wireless device, a request to enable usage of portion-based HARQ feedback. In some aspects, 1506A may be performed by TB processing component 198.

At 1506B, the second wireless device may communicate, with the second wireless device, a RRC signaling that enables a usage of portion-based HARQ feedback. For example, the second wireless device (e.g., 904 or 1004) may communicate, with the second wireless device, a RRC signaling that enables a usage of portion-based HARQ feedback. In some aspects, 1506B may be performed by TB processing component 198.

At 1506C, the second wireless device may transmit, to the first wireless device, a configuration that enables a usage of portion-based HARQ feedback. For example, the second wireless device (e.g., 904 or 1004) may transmit, to the first wireless device, a configuration that enables a usage of portion-based HARQ feedback. In some aspects, 1506C may be performed by TB processing component 198.

In some aspects, the resource reservation indicates a first set of PRBs or a first set of subchannels for the first transmission, where the at least one subsequent resource reservation indicates a second set of PRBs or a second set of subchannels for the second transmission, and where the first set of PRBs or the first set of subchannels is associated with a same quantity as the second set of PRBs or the second set of subchannels. In some aspects, the first transmission is associated with a MCS, and where the second transmission is associated with the MCS. In some aspects, the first transmission is associated with a first MCS, and where the second transmission is associated with a second MCS. In some aspects, the second wireless device may receive, from the first wireless device, second control information (e.g., 922 or 1022) associated with the second transmission, where the second control information indicates that the second transmission is associated with the first TB and the second TB.

At 1540, the second wireless device may transmit, to the first wireless device, a second HARQ feedback indicating a second decoding failure associated with a subset of portions associated with the at least one portion associated with the first TB and a sub-portion of the portion of the second TB. For example, the second wireless device (e.g., 904 or 1004) may transmit, to the first wireless device, a second HARQ feedback (e.g., 940 or 1040) indicating a second decoding failure associated with a subset of portions associated with the at least one portion associated with the first TB and a sub-portion of the portion of the second TB. In some aspects, 1540 may be performed by TB processing component 198.

At 1550, the second wireless device may receive, from the first wireless device, a third transmission including the subset of portions associated with the at least one portion associated with the first TB, the sub-portion of the portion of the second TB, and a third TB. For example, the second wireless device (e.g., 904 or 1004) may receive, from the first wireless device, a third transmission (e.g., 950 or 1050) including the subset of portions associated with the at least one portion associated with the first TB, the sub-portion of the portion of the second TB, and a third TB. In some aspects, 1550 may be performed by TB processing component 198.

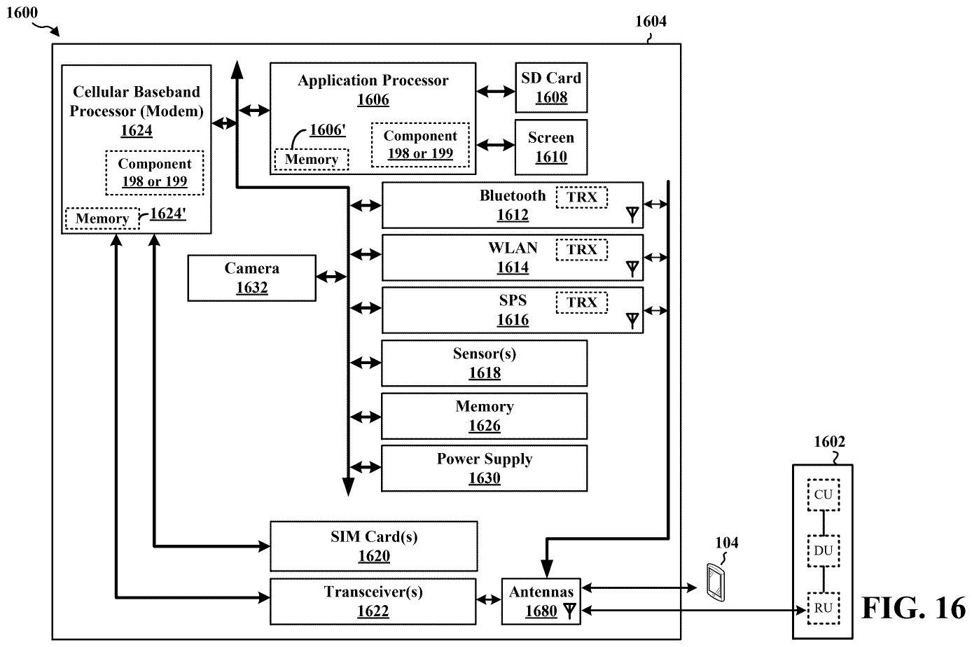

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the wireless device 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see wireless device 350 of FIG. 3) and include the additional modules of the apparatus 1604.

As discussed supra, the TB processing component 198 may be configured to transmit, to a second wireless device, a first transmission including a first TB associated with a set of portions, where control information associated with the first transmission includes a resource reservation for the first transmission and at least one subsequent resource reservation. In some aspects, the TB processing component 198 may be further configured to receive, from the second wireless device, a HARQ feedback indicating a decoding failure associated with at least one portion of the set of portion. In some aspects, the TB processing component 198 may be further configured to transmit, to the second wireless device, a second transmission based on the at least one subsequent resource reservation, where the second transmission includes the at least one portion of the set of portion associated with the first TB and at least a portion of a second TB. As discussed supra, the TB processing component 199 may be configured to receive, from a first wireless device, a first transmission including a first TB associated with a set of portions, where control information associated with the first transmission includes a resource reservation for the first transmission and at least one subsequent resource reservation. In some aspects, the TB processing component 199 may be further configured to transmit, to the first wireless device, a HARQ feedback indicating a decoding failure associated with at least one portion of the set of portion. In some aspects, the TB processing component 199 may be further configured to receive, from the first wireless device, a second transmission based on the at least one subsequent resource reservation, where the second transmission includes the at least one portion of the set of portion associated with the first TB and at least a portion of a second TB. In some aspects, the component 198 or 199 or another component of the apparatus may be further configured to perform any of the aspects described in connection with any of FIGS. 4-15.

The TB processing component 198 or the TB processing component 199 may be within the cellular baseband processor(s) 1624, the application processor(s) 1606, or both the cellular baseband processor(s) 1624 and the application processor(s) 1606. The component 198 or the component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for the functions described herein. In some aspects, the apparatus 1604 may be a first wireless device. In some aspects, the apparatus 1604 may include means for transmitting, to a second wireless device, a first transmission including a first TB associated with a set of portions, where control information associated with the first transmission includes a resource reservation for the first transmission and at least one subsequent resource reservation. In some aspects, the apparatus 1604 may include means for receiving, from the second wireless device, a HARQ feedback indicating a decoding failure associated with at least one portion of the set of portion. In some aspects, the apparatus 1604 may include means for transmitting, to the second wireless device, a second transmission based on the at least one subsequent resource reservation, where the second transmission includes the at least one portion of the set of portion associated with the first TB and at least a portion of a second TB. In some aspects, the apparatus 1604 may include means for receiving, from the second wireless device, a request to enable usage of portion-based HARQ feedback. In some aspects, the apparatus 1604 may include means for communicating, with the second wireless device, a RRC signaling that enables a usage of portion-based HARQ feedback. In some aspects, the apparatus 1604 may include means for receiving, from the second wireless device, a configuration that enables a usage of portion-based HARQ feedback. In some aspects, the apparatus 1604 may include means for transmitting, to the second wireless device, second control information associated with the second transmission, where the second control information indicates that the second transmission is associated with the first TB and the second TB. In some aspects, the apparatus 1604 may include means for receiving, from the second wireless device, a second HARQ feedback indicating a second decoding failure associated with a subset of portions associated with the at least one portion associated with the first TB and a sub-portion of the portion of the second TB. In some aspects, the apparatus 1604 may include means for transmitting, to the second wireless device, a third transmission including the subset of portions associated with the at least one portion associated with the first TB, the sub-portion of the portion of the second TB, and a third TB. In some aspects, the apparatus 1604 may be a second wireless device, the apparatus 1604 may include means for receiving, from a first wireless device, a first transmission including a first TB associated with a set of portions, where control information associated with the first transmission includes a resource reservation for the first transmission and at least one subsequent resource reservation. In some aspects, the apparatus 1604 may include means for transmitting, to the first wireless device, a HARQ feedback indicating a decoding failure associated with at least one portion of the set of portion. In some aspects, the apparatus 1604 may include means for receiving, from the first wireless device, a second transmission based on the at least one subsequent resource reservation, where the second transmission includes the at least one portion of the set of portion associated with the first TB and at least a portion of a second TB. In some aspects, the apparatus 1604 may include means for transmitting, to the first wireless device, a request to enable usage of portion-based HARQ feedback. In some aspects, the apparatus 1604 may include means for communicating, with the first wireless device, a RRC signaling that enables a usage of portion-based HARQ feedback. In some aspects, the apparatus 1604 may include means for transmitting, to the first wireless device, a configuration that enables a usage of portion-based HARQ feedback. In some aspects, the apparatus 1604 may include means for receiving, from the first wireless device, second control information associated with the second transmission, where the second control information indicates that the second transmission is associated with the first TB and the second TB. In some aspects, the apparatus 1604 may include means for transmitting, to the first wireless device, a second HARQ feedback indicating a second decoding failure associated with a subset of portions associated with the at least one portion associated with the first TB and a sub-portion of the portion of the second TB. In some aspects, the apparatus 1604 may include means for receiving, from the first wireless device, a third transmission including the subset of portions associated with the at least one portion associated with the first TB, the sub-portion of the portion of the second TB, and a third TB. In some aspects, the apparatus may further include means for performing any of the aspects described in connection with any of FIGS. 4-15.

The means may be the component 198 or the component 199 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

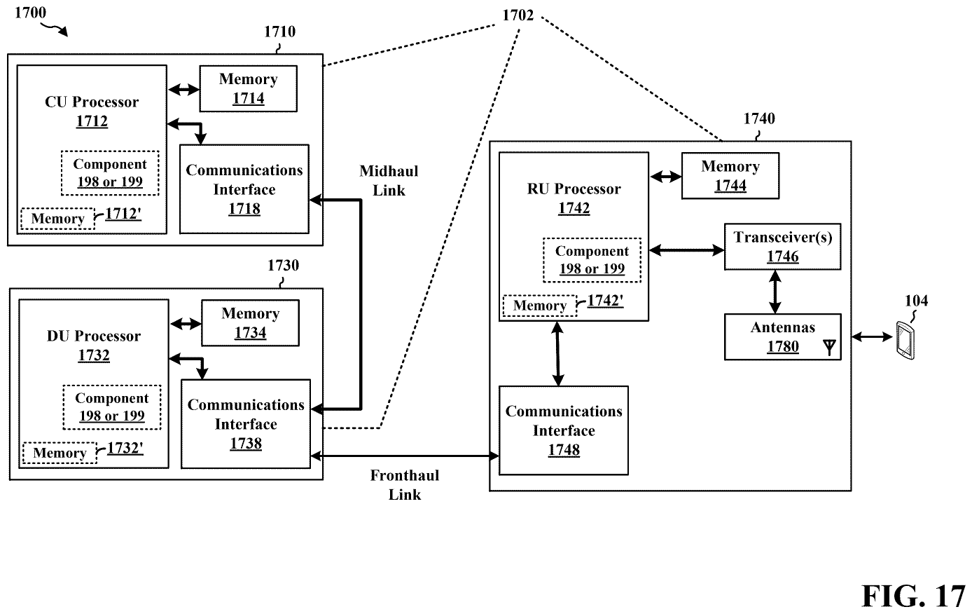

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the TB processing component 199 may be configured to receive, from a first wireless device, a first transmission including a first TB associated with a set of portions, where control information associated with the first transmission includes a resource reservation for the first transmission and at least one subsequent resource reservation. In some aspects, the TB processing component 199 may be further configured to transmit, to the first wireless device, a HARQ feedback indicating a decoding failure associated with at least one portion of the set of portion. In some aspects, the TB processing component 199 may be further configured to receive, from the first wireless device, a second transmission based on the at least one subsequent resource reservation, where the second transmission includes the at least one portion of the set of portion associated with the first TB and at least a portion of a second TB. As discussed supra, the TB processing component 199 may be configured to receive, from a first wireless device, a first transmission including a first TB associated with a set of portions, where control information associated with the first transmission includes a resource reservation for the first transmission and at least one subsequent resource reservation. In some aspects, the TB processing component 199 may be further configured to transmit, to the first wireless device, a HARQ feedback indicating a decoding failure associated with at least one portion of the set of portion. In some aspects, the TB processing component 199 may be further configured to receive, from the first wireless device, a second transmission based on the at least one subsequent resource reservation, where the second transmission includes the at least one portion of the set of portion associated with the first TB and at least a portion of a second TB.

The TB processing component 198 or the TB processing component 199 may be within one or more processors of one or more of the CU 1710, DU 1730, and the RU 1740. The component 198 or the component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In some aspects, the network entity 1702 may be a first wireless device. In some aspects, the network entity 1702 may include means for transmitting, to a second wireless device, a first transmission including a first TB associated with a set of portions, where control information associated with the first transmission includes a resource reservation for the first transmission and at least one subsequent resource reservation. In some aspects, the network entity 1702 may include means for receiving, from the second wireless device, a HARQ feedback indicating a decoding failure associated with at least one portion of the set of portion. In some aspects, the network entity 1702 may include means for transmitting, to the second wireless device, a second transmission based on the at least one subsequent resource reservation, where the second transmission includes the at least one portion of the set of portion associated with the first TB and at least a portion of a second TB. In some aspects, the network entity 1702 may include means for receiving, from the second wireless device, a request to enable usage of portion-based HARQ feedback. In some aspects, the network entity 1702 may include means for communicating, with the second wireless device, a RRC signaling that enables a usage of portion-based HARQ feedback. In some aspects, the network entity 1702 may include means for receiving, from the second wireless device, a configuration that enables a usage of portion-based HARQ feedback. In some aspects, the network entity 1702 may include means for transmitting, to the second wireless device, second control information associated with the second transmission, where the second control information indicates that the second transmission is associated with the first TB and the second TB. In some aspects, the network entity 1702 may include means for receiving, from the second wireless device, a second HARQ feedback indicating a second decoding failure associated with a subset of portions associated with the at least one portion associated with the first TB and a sub-portion of the portion of the second TB. In some aspects, the network entity 1702 may include means for transmitting, to the second wireless device, a third transmission including the subset of portions associated with the at least one portion associated with the first TB, the sub-portion of the portion of the second TB, and a third TB. In some aspects, the network entity 1702 may be a second wireless device, the network entity 1702 may include means for receiving, from a first wireless device, a first transmission including a first TB associated with a set of portions, where control information associated with the first transmission includes a resource reservation for the first transmission and at least one subsequent resource reservation. In some aspects, the network entity 1702 may include means for transmitting, to the first wireless device, a HARQ feedback indicating a decoding failure associated with at least one portion of the set of portion. In some aspects, the network entity 1702 may include means for receiving, from the first wireless device, a second transmission based on the at least one subsequent resource reservation, where the second transmission includes the at least one portion of the set of portion associated with the first TB and at least a portion of a second TB. In some aspects, the network entity 1702 may include means for transmitting, to the first wireless device, a request to enable usage of portion-based HARQ feedback. In some aspects, the network entity 1702 may include means for communicating, with the first wireless device, a RRC signaling that enables a usage of portion-based HARQ feedback. In some aspects, the network entity 1702 may include means for transmitting, to the first wireless device, a configuration that enables a usage of portion-based HARQ feedback. In some aspects, the network entity 1702 may include means for receiving, from the first wireless device, second control information associated with the second transmission, where the second control information indicates that the second transmission is associated with the first TB and the second TB. In some aspects, the network entity 1702 may include means for transmitting, to the first wireless device, a second HARQ feedback indicating a second decoding failure associated with a subset of portions associated with the at least one portion associated with the first TB and a sub-portion of the portion of the second TB. In some aspects, the network entity 1702 may include means for receiving, from the first wireless device, a third transmission including the subset of portions associated with the at least one portion associated with the first TB, the sub-portion of the portion of the second TB, and a third TB.

The means may be the component 198 or the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a first wireless device, including: at least one memory; and at least one processor coupled to the at least one memory, and based at least in part on information stored in the at least one memory, the at least one processor is configured to: transmit, to a second wireless device, a first transmission including a first transport block (TB) associated with a set of portions, where control information associated with the first transmission includes a resource reservation for the first transmission and at least one subsequent resource reservation; receive, from the second wireless device, a hybrid automatic repeat request (HARQ) feedback indicating a decoding failure associated with at least one portion of the set of portions; and transmit, to the second wireless device, a second transmission based on the at least one subsequent resource reservation, where the second transmission includes the at least one portion of the set of portions associated with the first TB and at least a portion of a second TB.

Aspect 2 is the apparatus of aspect 1, where the at least one processor is further configured to: receive, from the second wireless device, a request to enable usage of portion-based HARQ feedback.

Aspect 3 is the apparatus of any of aspects 1-2, where the at least one processor is further configured to: communicate, with the second wireless device, a radio resource control (RRC) signaling that enables a usage of portion-based HARQ feedback.

Aspect 4 is the apparatus of any of aspects 1-3, where the at least one processor is further configured to: receive, from the second wireless device, a configuration that enables a usage of portion-based HARQ feedback.

Aspect 5 is the apparatus of any of aspects 1-4, where the resource reservation indicates a first set of physical resource blocks (PRBs) or a first set of subchannels for the first transmission, where the at least one subsequent resource reservation indicates a second set of PRBs or a second set of subchannels for the second transmission, and where the first set of PRBs or the first set of subchannels is associated with a same quantity as the second set of PRBs or the second set of subchannels.

Aspect 6 is the apparatus of any of aspects 1-5, where the first transmission is associated with a modulation and coding scheme (MCS), and where the second transmission is associated with the MCS.

Aspect 7 is the apparatus of any of aspects 1-5, where the first transmission is associated with a first modulation and coding scheme (MCS), and where the second transmission is associated with a second MCS.

Aspect 8 is the apparatus of any of aspects 1-7, where the at least one processor is further configured to: transmit, to the second wireless device, second control information associated with the second transmission, where the second control information indicates that the second transmission is associated with the first TB and the second TB.

Aspect 9 is the apparatus of any of aspects 1-8, where the at least one processor is further configured to: receive, from the second wireless device, a second HARQ feedback indicating a second decoding failure associated with a subset of portions associated with the at least one portion associated with the first TB and a sub-portion of the portion of the second TB; and transmit, to the second wireless device, a third transmission including the subset of portions associated with the at least one portion associated with the first TB, the sub-portion of the portion of the second TB, and a third TB.

Aspect 10 is the apparatus of any of aspects 1-9, where the first transmission is a first physical sidelink shared channel (PSSCH) transmission, the control information is sidelink control information (SCI), and the second transmission is a second PSSCH transmission.

Aspect 11 is an apparatus for wireless communication at a second wireless device, including: at least one memory; and at least one processor coupled to the at least one memory, and based at least in part on information stored in the at least one memory, the at least one processor is configured to: receive, from a first wireless device, a first transmission including a first transport block (TB) associated with a set of portions, where control information associated with the first transmission includes a resource reservation for the first transmission and at least one subsequent resource reservation; transmit, to the first wireless device, a hybrid automatic repeat request (HARQ) feedback indicating a decoding failure associated with at least one portion of the set of portions; and receive, from the first wireless device, a second transmission based on the at least one subsequent resource reservation, where the second transmission includes the at least one portion of the set of portions associated with the first TB and at least a portion of a second TB.

Aspect 12 is the apparatus of aspect 11, where the at least one processor is further configured to: transmit, to the first wireless device, a request to enable usage of portion-based HARQ feedback.

Aspect 13 is the apparatus of any of aspects 11-12, where the at least one processor is further configured to: communicate, with the first wireless device, a radio resource control (RRC) signaling that enables a usage of portion-based HARQ feedback.

Aspect 14 is the apparatus of any of aspects 11-13, where the at least one processor is further configured to: transmit, to the first wireless device, a configuration that enables a usage of portion-based HARQ feedback.

Aspect 15 is the apparatus of any of aspects 11-14, where the resource reservation indicates a first set of physical resource blocks (PRBs) or a first set of subchannels for the first transmission, where the at least one subsequent resource reservation indicates a second set of PRBs or a second set of subchannels for the second transmission, and where the first set of PRBs or the first set of subchannels is associated with a same quantity as the second set of PRBs or the second set of subchannels.

Aspect 16 is the apparatus of any of aspects 11-15, where the first transmission is associated with a modulation and coding scheme (MCS), and where the second transmission is associated with the MCS.

Aspect 17 is the apparatus of any of aspects 11-15, where the first transmission is associated with a first modulation and coding scheme (MCS), and where the second transmission is associated with a second MCS.

Aspect 18 is the apparatus of any of aspects 11-17, where the at least one processor is further configured to: receive, from the first wireless device, second control information associated with the second transmission, where the second control information indicates that the second transmission is associated with the first TB and the second TB.

Aspect 19 is the apparatus of any of aspects 11-18, where the at least one processor is further configured to: transmit, to the first wireless device, a second HARQ feedback indicating a second decoding failure associated with a subset of portions associated with the at least one portion associated with the first TB and a sub-portion of the portion of the second TB; and receive, from the first wireless device, a third transmission including the subset of portions associated with the at least one portion associated with the first TB, the sub-portion of the portion of the second TB, and a third TB.

Aspect 20 is the apparatus of any of aspects 11-19, where the first transmission is a first physical sidelink shared channel (PSSCH) transmission, the control information is sidelink control information (SCI), and the second transmission is a second PSSCH transmission.

Aspect 21 is a method of wireless communication for implementing any of aspects 1 to 10.

Aspect 22 is a computer-readable medium (e.g., a non-transitory computer-readable medium) storing computer executable code, the code when executed by at least one processor causes the at least one processor to implement any of aspects 1 to 10.

Aspect 23 is an apparatus comprising means for implementing any of aspects 1 to 10.

Aspect 24 is a method of wireless communication for implementing any of aspects 11 to 20.

Aspect 25 is a computer-readable medium (e.g., a non-transitory computer-readable medium) storing computer executable code, the code when executed by at least one processor causes the at least one processor to implement any of aspects 11 to 20.

Aspect 26 is an apparatus comprising means for implementing any of aspects 11 to 20.

What is claimed is:

1. An apparatus for wireless communication at a first wireless device, comprising:
at least one memory; and
at least one processor coupled to the at least one memory, and based at least in part on information stored in the at least one memory, the at least one processor is configured to:
transmit, to a second wireless device, a first transmission comprising a first transport block (TB) associated with a set of portions, wherein control information associated with the first transmission comprises a resource reservation for the first transmission and at least one subsequent resource reservation;
receive, from the second wireless device, a hybrid automatic repeat request (HARQ) feedback indicating a decoding failure associated with at least one portion of the set of portions; and
transmit, to the second wireless device, a second transmission based on the at least one subsequent resource reservation, wherein the second transmission comprises the at least one portion of the set of portions associated with the first TB and at least a portion of a second TB.

2. The apparatus of claim 1, wherein the at least one processor is further configured to:
receive, from the second wireless device, a request to enable usage of portion-based HARQ feedback.

3. The apparatus of claim 1, wherein the at least one processor is further configured to:
communicate, with the second wireless device, a radio resource control (RRC) signaling that enables a usage of portion-based HARQ feedback.

4. The apparatus of claim 1, wherein the at least one processor is further configured to:
receive, from the second wireless device, a configuration that enables a usage of portion-based HARQ feedback.

5. The apparatus of claim 1, wherein the resource reservation indicates a first set of physical resource blocks (PRBs) or a first set of subchannels for the first transmission, wherein the at least one subsequent resource reservation indicates a second set of PRBs or a second set of subchannels for the second transmission, and wherein the first set of PRBs or the first set of subchannels is associated with a same quantity as the second set of PRBs or the second set of subchannels.

6. The apparatus of claim 1, wherein the first transmission is associated with a modulation and coding scheme (MCS), and wherein the second transmission is associated with the MCS.

7. The apparatus of claim 1, wherein the first transmission is associated with a first modulation and coding scheme (MCS), and wherein the second transmission is associated with a second MCS.

8. The apparatus of claim 1, wherein the at least one processor is further configured to:
transmit, to the second wireless device, second control information associated with the second transmission, wherein the second control information indicates that the second transmission is associated with the first TB and the second TB.

9. The apparatus of claim 1, wherein the at least one processor is further configured to:
receive, from the second wireless device, a second HARQ feedback indicating a second decoding failure associated with a subset of portions associated with the at least one portion associated with the first TB and a sub-portion of the portion of the second TB; and
transmit, to the second wireless device, a third transmission comprising the subset of portions associated with the at least one portion associated with the first TB, the sub-portion of the portion of the second TB, and a third TB.

10. The apparatus of claim 1, wherein the first transmission is a first physical sidelink shared channel (PSSCH) transmission, the control information is sidelink control information (SCI), and the second transmission is a second PSSCH transmission.

11. An apparatus for wireless communication at a second wireless device, comprising:
at least one memory; and
at least one processor coupled to the at least one memory, and based at least in part on information stored in the at least one memory, the at least one processor is configured to:
receive, from a first wireless device, a first transmission comprising a first transport block (TB) associated with a set of portions, wherein control information associated with the first transmission comprises a resource reservation for the first transmission and at least one subsequent resource reservation;
transmit, to the first wireless device, a hybrid automatic repeat request (HARQ) feedback indicating a decoding failure associated with at least one portion of the set of portions; and
receive, from the first wireless device, a second transmission based on the at least one subsequent resource reservation, wherein the second transmission comprises the at least one portion of the set of portions associated with the first TB and at least a portion of a second TB.

12. The apparatus of claim 11, wherein the at least one processor is further configured to:
transmit, to the first wireless device, a request to enable usage of portion-based HARQ feedback.

13. The apparatus of claim 11, wherein the at least one processor is further configured to:
communicate, with the first wireless device, a radio resource control (RRC) signaling that enables a usage of portion-based HARQ feedback.

14. The apparatus of claim 11, wherein the at least one processor is further configured to:
transmit, to the first wireless device, a configuration that enables a usage of portion-based HARQ feedback.

15. The apparatus of claim 11, wherein the resource reservation indicates a first set of physical resource blocks (PRBs) or a first set of subchannels for the first transmission, wherein the at least one subsequent resource reservation indicates a second set of PRBs or a second set of subchannels for the second transmission, and wherein the first set of PRBs or the first set of subchannels is associated with a same quantity as the second set of PRBs or the second set of subchannels.

16. The apparatus of claim 11, wherein the first transmission is associated with a modulation and coding scheme (MCS), and wherein the second transmission is associated with the MCS.

17. The apparatus of claim 11, wherein the first transmission is associated with a first modulation and coding scheme (MCS), and wherein the second transmission is associated with a second MCS.

18. The apparatus of claim 11, wherein the at least one processor is further configured to:
receive, from the first wireless device, second control information associated with the second transmission, wherein the second control information indicates that the second transmission is associated with the first TB and the second TB.

19. The apparatus of claim 11, wherein the at least one processor is further configured to:
transmit, to the first wireless device, a second HARQ feedback indicating a second decoding failure associated with a subset of portions associated with the at least one portion associated with the first TB and a sub-portion of the portion of the second TB; and
receive, from the first wireless device, a third transmission comprising the subset of portions associated with the at least one portion associated with the first TB, the sub-portion of the portion of the second TB, and a third TB.

20. A method for wireless communication performed by a first wireless device, comprising:
transmitting, to a second wireless device, a first transmission comprising a first transport block (TB) associated with a set of portions, wherein control information associated with the first transmission comprises a resource reservation for the first transmission and at least one subsequent resource reservation;
receiving, from the second wireless device, a hybrid automatic repeat request (HARQ) feedback indicating a decoding failure associated with at least one portion of the set of portions; and
transmitting, to the second wireless device, a second transmission based on the at least one subsequent resource reservation, wherein the second transmission comprises the at least one portion of the set of portions associated with the first TB and at least a portion of a second TB.
